(19) United States
(12) Patent Application Publication
(10) Pub. No.: US 2026/0348019 A1
(43) Pub. Date: Nov. 5, 2026

(54) METHOD OF IN-SITU FORMING MAGNETITE PROTECTIVE COATING AGAINST CARBON STEEL TUBING CORROSION FOR OILFILED APPLICATIONS

(71) Applicant: SAUDI ARABIAN OIL COMPANY, Dhahran (SA)

(72) Inventors: Tao Chen, Dhahran (SA); Qiwei Wang, Dhahran (SA)

(73) Assignee: SAUDI ARABIAN OIL COMPANY, Dhahran (SA)

(21) Appl. No.: 19/197,022

(22) Filed: May 2, 2025

(51) Int. Cl. C23C 22/62; C23C 22/68; C23C 22/73

(52) U.S. Cl. CPC C23C 22/62; C23C 22/68; C23C 22/73

(57) ABSTRACT

A method including contacting downhole carbon steel tubing with a solution including high total dissolved solids (TDS) content and an oxidizer thereby producing ferrous iron(II) ions from the carbon steel tubing and forming a magnetite film on an interior surface of the carbon steel tubing. A method including injecting a solution including ferrous iron(II) ions into downhole carbon steel tubing, injecting a strong alkaline solution at a pH ranging from 9 to 14 to the solution to form a mixed solution thereby forming a magnetite film on an interior surface of the carbon steel tubing. A method including introducing a solution for forming magnetite into the carbon steel tubing proximate a damaged section, soaking the damaged section with the solution for 2 hours to 48 hours at a temperature of 20 °C to 90 °C thereby precipitating magnetite to form a protective film covering at least a portion of the damaged section.

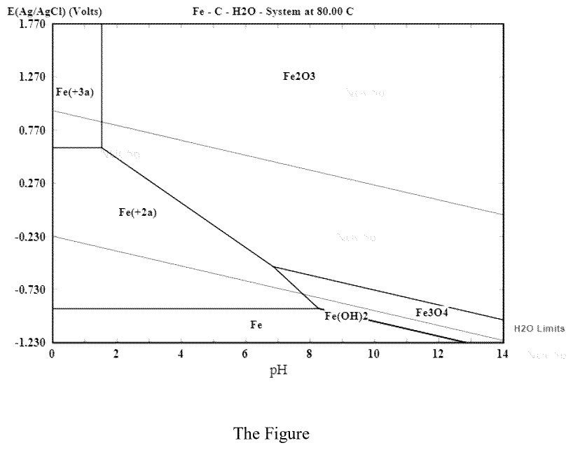

### BACKGROUND

Carbon steel tubing has been widely used as a cost-effective choice for materials in oil and gas fields. However, the failure of carbon steel pipes due to corrosion can lead to leaks and result in costly damage. Corrosion of metal in the presence of water is a common problem across oil and gas production. The presence of corrosive materials such as carbon dioxide (CO₂) and hydrogen sulfide (H₂S) exacerbates the problem. The carbon steel production tubing can fail prematurely due to either general corrosion or pitting corrosion.

Using more expensive corrosion-resistant alloys or surface coating(s) are methods commonly used to prevent corrosion in carbon steel pipes. Current coating techniques and materials on carbonate steel, such as polymer, PTFE, ceramic, etc., have their limitations due to temperature stability, abrasion resistance, offline treatment, complex manufacturing, and economic concerns. Therefore, there are concerns about applying coating techniques using the current coating technologies in the oilfield in order to effectively and economically control tubing corrosion. Accordingly, there exists a need for simpler methods and compositions that address these limitations.

### SUMMARY

This summary is provided to introduce a selection of concepts that are further described below in the detailed description. This summary is not intended to identify key or essential features of the claimed subject matter, nor is it intended to be used as an aid in limiting the scope of the claimed subject matter.

In one aspect, embodiments disclosed herein relate to a method including contacting downhole carbon steel tubing with a solution including a high total dissolved solids (TDS) content and an oxidizer thereby producing ferrous iron(II) ions from the carbon steel tubing and forming a magnetite film on an interior surface of the carbon steel tubing.

In another aspect, embodiments disclosed herein relate to a method including injecting a solution including ferrous iron(II) ions into downhole carbon steel tubing, injecting a strong alkaline solution at a pH ranging from 9 to 14 to the solution to form a mixed solution downhole thereby forming a magnetite film on an interior surface of the carbon steel tubing.

In yet another aspect, embodiments disclosed herein relate to a method for treating downhole carbon steel tubing, the method including introducing a solution for forming magnetite into the carbon steel tubing proximate a damaged section, soaking the damaged section with the solution for a time period ranging from 2 hours to 48 hours and at a temperature of 20 °C to 90 °C thereby precipitating magnetite to form a protective film covering at least a portion of the damaged section.

Other aspects and advantages of the claimed subject matter will be apparent from the following description and the appended claims.

### BRIEF DESCRIPTION OF DRAWINGS

The FIGURE is a potential pH-diagram for an Fe—H₂O system at 80 °C as described in accordance with one or more embodiments.

### DETAILED DESCRIPTION

The following description outlines the use of an in-situ magnetite (Fe₃O₄) coating method to control the corrosion of carbon steel. This in-situ technique used to create a magnetite protective film on the interior surface of carbon steel tubes, creatively providing oilfield corrosion control on carbon steel tubing. The coating modifies the surface of carbon steel with an in-situ formed Fe₃O₄ layer, which prevents contact by creating a barrier between the produced water and the surface of carbon steel. The formed protective layer results in reducing the formation of further corrosion of carbon steel which can significantly benefit wells completed with carbon steel and/or that have corrosion issues.

Magnetite can form a dense and thin layer on a steel surface in weakly oxidized environments. Magnetite has a galvanic effect on carbon steel, particularly in the presence of a high temperature and high-pressure environment. The chemically bonded magnetite on carbon steel protects it from further corrosion. The thickness and density of the layer may be controlled by the concentrations of the reacting chemicals, the pH of the environment, the reaction kinetics under certain temperatures and pressures, and other types of chemical additives and their concentrations. This allows for the precipitation of a thin and uniform magnetite layer. The magnetite layer is inert to the composition of fluids flowing through the pipe. Moreover, the magnetite layer can be in-situ fixed or healed if the layer is cracked or damaged. When the layer cracks, the reactants can be pumped to the target position and produce magnetite to heal the original cracked layer.

The methods disclosed herein may utilize simple batch chemical treatments with the following reagents alone or in combination as described in greater detail below: a high total dissolved solids content, iron(II) ions, oxidizers (e.g., nitrate or nitrite), and strong alkaline solutions. The chemical treatments including some or all of these reagents may be used to treat carbon steel tubing. As used herein, the chemical treatment may be referred to as the “solution,” the “treatment solution,” or the “reactive solution” interchangeably. Further, the solutions described herein may be incorporated with other treatment fluids used in an oil and gas production well as well as produced fluids. However, these aforementioned reagents and solutions may also be mixed with other high TDS water to increase the TDS of produced fluids or solutions.

According to one or more embodiments, the carbon steel tubing may include but is not limited to low carbon steels/mild steels such as those including up to 0.3% carbon, medium carbon steels with 0.3-0.6% carbon and high carbon steels with more than 0.6% carbon.:

The base fluid for the solutions described herein includes water. The water may comprise one or more known compositions of water, including distilled; condensed; filtered or unfiltered fresh surface or subterranean waters, such as water sourced from lakes, rivers or aquifers; mineral waters; gray, brown, black, and blue waters; run-off, storm or waste water; potable or non-potable waters; brackish waters; synthetic or natural sea waters; synthetic or natural brines; formation waters; production water; and combinations thereof. The solutions described herein may have a high total dissolved solids (TDS) content. The high TDS content corresponds to a dissolved solids concentration ranging from 50 g/L to 380 g/L, such as from a lower limit of any one of 50, 75, 100 or 150 g/L, to an upper limit of any one of 200, 250, 300, 250 or 380 g/L, where any lower limit may be paired with any mathematically compatible upper limit. Further, the solutions may include salts such as sodium chloride, calcium chloride and magnesium chloride. If the TDS content is below 50 g/L, these salts may be added to increase the TDS content. The salts and/or additional solids may be provided from sources including the produced water and/or other solids-containing water sources described above, or may be added as solids.

As noted above, treatment compositions include ferrous iron (i.e., iron (II)). This ferrous iron may be present in the chemical treatments herein from the addition of specific iron-containing salts. However, it also may be present downhole without having to specifically add the iron salts. In particular, the ferrous iron ions may exist due to previous corrosion that is present on the carbon steel tubing, resulting in iron(II) ions in solution. In other embodiments, corrosion may be intentionally generated from the injection of the reactive solutions and components described herein, also resulting in iron(II) ions. Therefore, the ferrous ions may be already present or they may be added in an amount to generate a magnetite coating with a thickness ranging from 0.1 to 2 microns, such as from a lower limit of any one of 0.1, 0.2, 0.5 or 1 micron to 1.2, 1.5, 1.8 or 2 microns, where any lower limit may be paired with any mathematically compatible upper limit. Coatings of the required thickness may be made through (1) corrosion induced Fe₃O₄ deposition, and (2) Fe₃O₄ surface deposition introduced by iron (II) in solutions

When iron (II) ions are provided in the form of a salt that may be dissolved in the solution used to treat the downhole carbon steel tubing, the iron-containing salt may include but is not limited to iron (II) chloride (FeCl₂), iron (II) nitrate (Fe(NO₃)₂), etc. The iron salts may be added to provide an iron (II) ion concentration ranging from 50 ppm to 150,000 ppm, such as from a lower limit of any one of 50, 100, 1000 or 10,000 ppm, to an upper limit of any one of 50,000, 100,000 or 150,000 ppm, where any lower limit may be paired with any mathematically compatible upper limit.

As described above, the solution may also include an oxidizer. According to one or more embodiments, the oxidizer is nitrate (NO₃⁻) ions. The oxidizer serves the purpose of partially oxidizing the previously described ferrous iron. The concentration of the nitrate ranges from 50 ppm to 370,000 ppm, such as from a lower limit of any one of 50, 100, 1000, 10,000, 50,000 or 75,000 ppm, to an upper limit of any one of 100,000, 150,000, 200,000, 300,000 or 370,000 ppm, where any lower limit may be paired with any mathematically compatible upper limit. Further, the nitrate ions may be added to the solution in the form of one or more nitrate salts including but not limited to sodium nitrate (NaNO₃), potassium nitrate (KNO₃), etc. Nitrate ions from the iron salt may also be utilized. The iron (II) ions are partially oxidized to form iron(III) by the nitrate ions according to redox reaction (1) to form the iron(II, III) oxide expressed as Fe₃O₄:

15Fe²⁺+2NO₃⁻+14H₂O→5Fe₃O₄(s)+N₂(g)+28H⁺ (1)

In redox reaction (1), the iron(II) is partially oxidized which allows for magnetite film formation and precipitation. During film formation, Fe₃O₄ is deposited on the surface of completion tubing, which contributes to corrosion protection. In precipitation, however, the precipitated Fe₃O₄ is in the bulk solution, which will flow back to the surface and not contribute to corrosion protection.

The partial oxidation of the dissolved Fe²⁺ or Fe(II) by nitrate may be an abiotic (chemical) or a microbial process. Without catalysts (e.g., Cu²⁺, Fe, Mn, C, P, N, S, Cr, Co, As, Sb, Se, Hg, Tc, and U of various oxidation states), abiotic Fe(II) oxidation by nitrate is slow at circumneutral conditions (pH between 6.5 and 7.5). Faster precipitation reflects that the reaction(s) following nitrate-Fe(II) addition may be microbially mediated. Microbes such as nitrate-dependent Fe(II) oxidizers can accelerate Fe(II) oxidation by nitrate and subsequent mineral precipitation. The microbes for nitrate-dependent Fe(II) oxidizer include but are not limited to Anammox bacteria, Thiobacillus denitrificans, Thiobacillus denitrificans, etc. The target pH for oxidation proceeding according to reaction (1) ranges from 6.5 to 9. For reaction (1), the temperature should range from 20 °C to 80 °C, such as from a lower limit of any one of 20, 30, 40 or 50 °C, to an upper limit of any one of 55, 65, 75, or 80 °C, where any lower limit may be paired with any mathematically compatible upper limit.

The oxidizer may also be nitrite (NO₂⁻) ions that are present at a concentration ranging from 50 ppm to 280,000 ppm, such as from a lower limit of any one of 50, 100, 1000, 10,000, 50,000 or 75,000 ppm, to an upper limit of any one of 100,000, 150,000, 200,000, 250,000 or 280,000 ppm, where any lower limit may be paired with any mathematically compatible upper limit. The nitrite ions may be provided by salt solutions that include but are not limited to sodium nitrite (NaNO₂), potassium nitrite (KNO₂), etc. The iron (II) ions are partially oxidized to form iron(III) by the nitrite ions according to redox reaction (2) to precipitate the iron(II, III) oxide as a magnetite film:

9Fe²⁺+2NO₂⁻+8H₂O→3Fe₃O₄(s)+N₂(g)+16H⁺ (2)

In contrast to nitrate, nitrite is an effective oxidant of Fe(II), making redox reaction (2) a relatively rapid abiotic process. For reaction (2), the temperature should range from 20 °C to 80 °C, such as from a lower limit of any one of 20, 30, 40 or 50 °C, to an upper limit of any one of 55, 65, 75, or 80 °C, where any lower limit may be paired with any mathematically compatible upper limit.

The solution comprising the oxidizer may also be in a strong alkaline solution. The strong alkaline solution/environment includes strong bases which increase the pH of the solution/environment. The target pH of the high pH solution ranges from 9 to 14. The strong bases may include but are not limited to sodium hydroxide (NaOH), potassium hydroxide (KOH), potassium carbonate (K₂CO₃), etc. The strong alkaline solutions may be used for developing thicker oxides. As shown in the figure, if the pH of the solution ranges from 9 to 14 and electrical potential falls in the region of stable magnetite, either the ferrous ion or the metastable ferrous hydroxide can be oxidized to magnetite via Schikorr reaction (3):

3Fe²⁺+4H₂O→Fe₃O₄(s)+8H⁺+2e⁻ (3)

Schikorr reaction (3) is a spontaneous chemical process and does not require the application of an electrical potential for the precipitation to occur downhole. As such, the figures generally shows the different iron oxide that may form under various conditions with electrical potential.

Oxidation that occurs according to reaction (3) provides the target oxidized layer with a thickness ranging from 0.1 to 2 microns. However, the reaction rate of reaction (3) under high pH is quicker than the reaction rate of reaction (1). Therefore, reaction (3) can deposit oxides/layer quicker than reaction (1). For the Schikorr reaction, the temperature should range from 25 °C to 90 °C, such as from a lower limit of any one of 25, 35, 40 or 45 °C, to an upper limit of any one of 50, 60, 70, 80 or 90 °C, where any lower limit may be paired with any mathematically compatible upper limit.

The generation of the magnetite layer may also include combinations of the reagents described above. As a non-limiting example, nitrate can be used in both the acidic and alkaline environments. However, the reaction under alkaline conditions will proceed quicker as described above. Further, the amounts of the nitrate and nitrate may be used in the amounts described above.

The above-described solution components and their combinations may be utilized to perform in-situ magnetite film formation in downhole carbon steel tubing. The above-described solutions and components thereof may also be used to perform repairs to treat downhole carbon steel tubing. Various methods may be used, as described as follows.

In another aspect, embodiments disclosed herein relate to a method comprising contacting downhole carbon steel tubing with a solution comprising a high total dissolved salt (TDS) content and an oxidizer thereby producing ferrous iron(II) ions from the carbon steel tubing and forming a magnetite film on an interior surface of the carbon steel tubing.

When the solution comprising the high TDS content is contacted with the downhole carbon steel tubing, surface corrosion, in the form of ferrous iron (II) ions, is generated on the interior surface of the carbon steel tubing. When the ferrous iron(II) forms on the surface of the tubing due to the corrosion, the generated iron(II) ions react with an oxidizer (e.g., nitrate or nitrite ions) to immediately form chemically bonded magnetite (Fe₃O₄) as a protective film on the interior surface of carbon steel tubing.

As discussed above, the contacting step between the high TDS solution and the downhole carbon steel tubing may be chemically or microbially mediated. The high TDS solutions can be injected into downhole completion tubing using coil tubing or any other suitable tubing to deliver the solution to a desired portion(s) of an interior surface of the tubing. Further, the temperature for contacting should range from 20 °C to 90 °C in accordance with the reactions described above.

Typically, the contacting should occur for a period of time, a soaking period, ranging from 2 hours to 48 hours, such as from a lower limit of any one of 2, 5, 10, 15 or 20 hours, to an upper limit of any one of 24, 30, 36, 42 or 48 hours, where any lower limit may be paired with any mathematically compatible upper limit. A soaking time within this range facilitates the formation of sufficient Fe(II) ions for the reactions outlined above. Further, and depending on the method/reaction used to generate the magnetite layer, the pH of the injection solution should range from a pH of 9 to 14. The method may also include the use of additives incorporated with the TDS solution. The catalysts may include those described in connection with the abiotic microbially mediated reaction (2) above.

As a non-limiting example, the methods described herein may be performed as a treatment after completion and before production, when the surface of completion tubing is ready to treat. The method may also be used after production as well, or on an as-needed basis.

In another aspect, embodiments disclosed herein relate to a method comprising injecting a solution comprising ferrous iron(II) ions into downhole carbon steel tubing; injecting a strong alkaline solution to the solution to form a mixed solution downhole thereby forming a magnetite film on an interior surface of the carbon steel tubing. As non-limiting examples, the solution comprising the ferrous iron(II) ions may be injected using coil tubing. The strong alkaline solution may be injected in an amount to achieve a target pH.

As noted above, the concentration of iron(II) ions in the solution ranges from 50 to 150,000 ppm. The concentration of the iron(II) ions may be determined in a laboratory with detailed field application conditions. From the analysis of the iron(II) ion concentration, the solution may be supplemented with an amount of additional iron salts to increase the iron(II) ion to within the range above.

In yet another aspect, embodiments disclosed herein relate to a method for treating downhole carbon steel tubing, the method comprising introducing a solution for forming magnetite into the carbon steel tubing proximate a damaged section; soaking the damaged section with the solution for a time period ranging from 2 to 48 hours and at a temperature of 20 °C to 90 °C thereby precipitating magnetite to form a protective film covering at least a portion of the damaged section. The method advantageously does not require and therefore excludes the removal of pre-existing corroded material. Thus, the method may be used to control corrosion in production tubing, contribute to maintaining production, and prevent loss of well control.

As mentioned above, the method may include introducing a solution for forming magnetite into the downhole carbon steel tubing proximate a damaged section. The damaged section of the carbon steel tubing may be a newly identified damaged section within a production well. Further, the damaged section may be a previously repaired damaged section. Chemical or mechanical disruption of the magnetite film may lead to the initiation of local corrosion or cracks. The magnetite (Fe₃O₄) layer can be in-situ fixed or healed if the layer is cracked or damaged. When the layer cracks, the reactants can be pumped to the target position/damaged section and produce a new magnetite (Fe₃O₄) protective film to heal the original cracked layer.

According to one or more embodiments, the damaged section that may have been previously repaired may include sections that have been repaired using conventional carbon steel coating technologies. The previously repaired section may also include damaged sections repaired according to the disclosure described herein. In any suitable scenario, the method may include introducing any suitable solution comprising any suitable combination of magnetite film forming components described herein to form a protective magnetite film of 0.1 to 2 microns for the damaged section.

As a non-limiting example, in oil and gas industry, normally a multi-finger caliper is used to identify corrosion (general and pitting corrosion) in downhole completion tubing. Once a section has been identified as containing corrosion, the solutions and the magnetite forming components may be pumped to the targeted location using coil tubing.

Additionally, a previously repaired section may also be evaluated with a multi-finger caliper to identify corrosion at different times. Then, the corrosion may be compared to the corrosion over time to confirm if an extra repair is needed to prevent/reduce the corrosion rate of the damaged section. Thus, the methods described herein may be used to mitigate corrosion for the new or partially corroded tubing to increase the service life of tubing.

Embodiments of the present disclosure may provide at least one of the following advantages. The method described herein may significantly benefit wells completed with carbon steel tubing and that have corrosion or experience corrosion problems. The methods may assist in preventing and/or reducing tubing corrosion, lower operational expenditures due to a simplified in-situ method described herein. The method may also be advantageously used to increase the durability of carbon steel to lower capital expenditures.

Although only a few example embodiments have been described in detail above, those skilled in the art will readily appreciate that many modifications are possible in the example embodiments without materially departing from this invention. Accordingly, all such modifications are intended to be included within the scope of this disclosure as defined in the following claims.

What is claimed:

1. A method comprising:
contacting downhole carbon steel tubing with a solution comprising a high total dissolved solids (TDS) content and an oxidizer thereby producing ferrous iron(II) ions from the carbon steel tubing and forming a magnetite film on an interior surface of the carbon steel tubing.

2. The method of claim 1, wherein a thickness of the magnetite film ranges from 0.1 to 2 microns.

3. The method of claim 1, wherein the oxidizer is a nitrate ions or a nitrite ions.

4. The method of claim 3, wherein a concentration of the nitrate ions ranges from 50 ppm to 370,000 ppm.

5. The method of claim 4, wherein the nitrate ions are provided from a nitrate salt selected from the group consisting of sodium nitrate, potassium nitrate and mixtures thereof.

6. The method of claim 3, wherein a concentration of the nitrite ions ranges from 50 ppm to 280,000 ppm.

7. The method of claim 3, wherein the nitrite is selected from the group consisting of sodium nitrite, potassium nitrite and mixtures thereof.

8. The method of claim 1, wherein the high TDS concentration ranges from 50 g/L to 380 g/L.

9. The method of claim 1, wherein the TDS includes salt selected from the group consisting of sodium chloride, calcium chloride and magnesium chloride.

10. The method of claim 1, wherein the contacting is performed at a temperature ranging from 20 °C to 90 °C.

11. The method of claim 3, wherein the contacting is performed at a pH ranging from 6.5 to 9.

12. The method of claim 1, wherein the contacting is chemically mediated.

13. The method of claim 1, wherein contacting is microbially mediated.

14. A method comprising:
injecting a solution comprising ferrous iron(II) ions into downhole carbon steel tubing;
injecting a strong alkaline solution at a pH ranging from 9 to 14 to the solution to form a mixed solution downhole thereby forming a magnetite film on an interior surface of the carbon steel tubing.

15. The method of claim 14, wherein the solution comprises ferrous iron(II) ions at a concentration ranging from 50 ppm to 150,000 ppm.

16. The method of claim 14, wherein the ferrous iron(II) ions are derived from iron salts selected from the group consisting of iron chloride, iron nitrate and mixtures thereof.

17. The method of claim 14, wherein a thickness of the magnetite film ranges from 0.1 to 2 microns.

18. A method for treating downhole carbon steel tubing, the method comprising:
introducing a solution for forming magnetite into the carbon steel tubing proximate a damaged section;
soaking the damaged section with the solution for a time period ranging from 2 hours to 48 hours and at a temperature of 20 °C to 90 °C thereby precipitating magnetite to form a protective film covering at least a portion of the damaged section.

19. The method of claim 18, wherein the method excludes removal of pre-existing corroded material.

20. The method of claim 18, wherein a thickness of the protective film ranges from 0.1 to 2 microns.
